(19) United States
(12) Patent Application Publication
(10) Pub. No.: US 2025/0392148 A1
(43) Pub. Date: Dec. 25, 2025

(54) ELECTRONIC APPARATUS AND CONTROL METHOD

(71) Applicant: CANON KABUSHIKI KAISHA, Tokyo (JP)

(72) Inventor: IPPEI UCHIDA, Tokyo (JP)

(21) Appl. No.: 19/233,053

(22) Filed: Jun. 10, 2025

(30) Foreign Application Priority Data
Jun. 25, 2024 (JP) 2024-102223

(51) Int. Cl. H02J 7/00; H01M 10/42

(52) U.S. Cl. CPC H02J 7/0063; H02J 7/0024; H01M 10/425; H01M 2010/4278

(57) ABSTRACT

An electronic apparatus that can be attached with a plurality of batteries, includes a control unit configured to switch a battery for supplying power to the apparatus based on information indicating a power supply state of each of the plurality of batteries and, when the information meets a predetermined case for the plurality of batteries, perform shutdown processing of the apparatus. The control unit obtains the information in a manner that differs between a case where the plurality of batteries are of the same type and a case where the plurality of batteries are of different types.

### BACKGROUND

### Field of the Technology

The present disclosure relates to an electronic apparatus that can be attached with a plurality of types of batteries, and a control method.

### Description of the Related Art

In order to cope with the increased power consumption due to the improved performance of an electronic apparatus such as a digital camera, batteries compatible with high power have been developed. A use case is assumed in which a conventional high power incompatible battery and a high power compatible battery are attached to and used in an electronic apparatus.

When the remaining capacity of a battery decreases, the output power decreases. Therefore, when using a high power incompatible battery, a situation can occur in which the supply power of the battery becomes lower than the power consumption of an electronic apparatus. In this case, in order to prevent an instantaneous power interruption in the electronic apparatus, there is a need to shut down the electronic apparatus even if the battery has the remaining capacity. This shortens the operable time of the electronic apparatus. On the other hand, when using a high power compatible battery, since the supply power of the battery is always higher than the power consumption of an electronic apparatus, the battery can be used until the capacity of the battery is run out, that is, until the nominal capacity is discharged.

Japanese Patent Laid-Open No. 02-299428 describes a technique for driving an electronic apparatus for a long time by changing, in accordance with the type of the battery attached to the electronic apparatus, the voltage at which the electronic apparatus is shut down.

However, conventionally, it has not been assumed that a plurality of types of batteries are attached to and used in an electronic apparatus. It is desirable to enable maximum use of the plurality of types of batteries.

### SUMMARY

The present disclosure has been made in consideration of the aforementioned problems, and realizes a technique for enabling maximum use of a plurality of types of batteries attached to an electronic apparatus.

The present disclosure is directed to an electronic apparatus that can be attached with a plurality of batteries, comprising: a control unit configured to switch a battery for supplying power to the apparatus based on information indicating a power supply state of each of the plurality of batteries and, when the information meets a predetermined case for the plurality of batteries, perform shutdown processing of the apparatus, wherein the control unit obtains the information in a manner that differs between a case where the plurality of batteries are of the same type and a case where the plurality of batteries are of different types.

The present disclosure is directed to a control method of an electronic apparatus that can be attached with a plurality of batteries, the method comprising: switching a battery for supplying power to the electronic apparatus based on information indicating power supply states of the plurality of batteries; and performing shutdown processing of the electronic apparatus when the information meets a predetermined case for the plurality of batteries, wherein the switching is obtaining the information in a manner that differs between a case where the plurality of batteries are of the same type and a case where the plurality of batteries are of different types.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are external views of an electronic apparatus and a battery attachable to the electronic apparatus according to a present embodiment;

FIGS. 2A and 2B are external views of a battery grip attachable to an electronic apparatus and batteries attachable to the battery grip according to the present embodiment;

FIG. 3 is a block diagram illustrating the internal configurations of the electronic apparatus and the battery attachable to the electronic apparatus according to the present embodiment;

FIG. 4 is a block diagram illustrating the internal configurations of an electronic apparatus and a battery grip attachable to the electronic apparatus according to a first embodiment;

FIG. 5 is a circuit diagram illustrating the configurations of a power supply switching unit according to the first embodiment;

FIG. 6 is a view illustrating ON and OFF states of switches of the power supply switching unit according to the first embodiment;

FIG. 7 is a block diagram illustrating the internal configurations of an electronic apparatus and a battery grip attachable to the electronic apparatus according to a second embodiment;

FIG. 8 is a circuit diagram illustrating the configurations of a power supply switching unit according to the second embodiment; and

FIG. 9 is a view illustrating ON and OFF states of switches of the power supply switching unit according to the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

An example will be described below in which an electronic apparatus according to the present disclosure is applied to an image capturing apparatus such as a single-lens reflex digital camera capable of recording a moving image and shooting a still image.

Note that the electronic apparatus according to a present embodiment is not limited to an image capturing apparatus, and may be a portable communication terminal or information processing terminal such as a smartphone or a tablet computer.

In the present embodiment, a plurality of types of batteries can be attached to a digital camera, and a battery for supplying power to the digital camera is switched based on information (operable time, voltage, remaining capacity, or the like) indicating the power supply state of each of the plurality of batteries. When the information meets a predetermined case (the operable time is zero, or the voltage or remaining capacity is lower than a threshold) for the plurality of batteries, shutdown processing of the digital camera is performed.

### First Embodiment

A first embodiment will be described below.

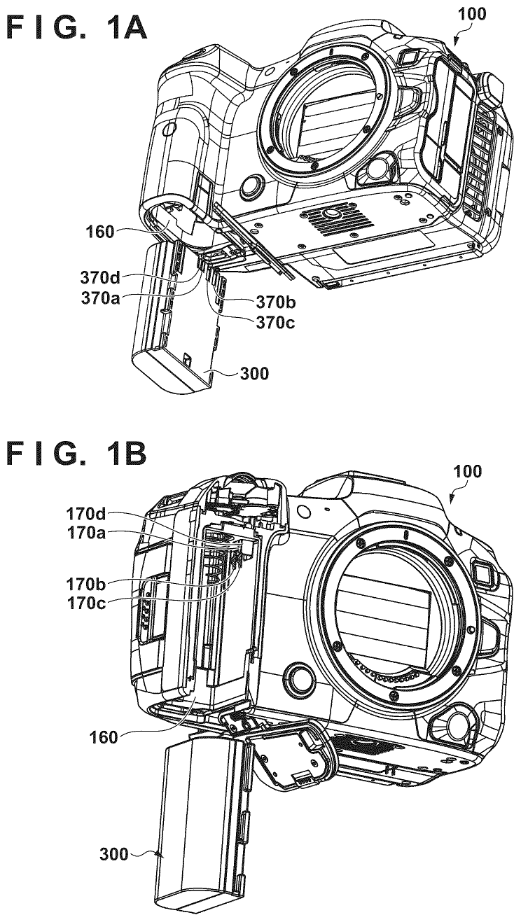

First, with reference to FIGS. 1A and 1B, the outer appearances of a digital camera and a battery attachable to the digital camera, and a connection form according to a present embodiment will be described.

FIG. 1A is a perspective view illustrating the outer appearance of a camera body with a lens unit removed from the digital camera, the outer appearance of a battery attachable to the camera body, and a connection form according to the present embodiment.

FIG. 1B is a perspective view illustrating the connection form between the camera body and the battery according to the present embodiment in a state in which the battery attachment portion of the camera body is partially cut out.

In the digital camera according to the present embodiment, a lens unit (interchangeable lens) (not shown) can be attached/detached to/from a camera body 100. The camera body 100 is provided with a battery storage portion 160 for attachment of a battery 300. The battery storage portion 160 is provided in a grip portion which a user grasps with the right hand when holding the camera body 100. The battery storage portion 160 mechanically and electrically connects the battery 300 to the camera body 100

In a state in which the battery 300 is stored in the camera body 100, contacts 370a to 370d provided on the battery 300 contact contacts 170a to 170d provided on the camera body 100, and the battery 300 and the camera body 100 are electrically connected.

The contact 370a is the plus terminal of the battery 300, and the contact 370d is the minus terminal of the battery 300. The contact 170a is the plus terminal of the camera body 100, and the contact 170d is the minus terminal of the camera body 100. When the battery 300 is attached to the battery storage portion 160, the contacts 370a and 370d of the battery 300 are electrically connected to the contacts 170a and 170d of the camera body 100, and power is supplied from the battery 300 to the camera body 100. The contact 370b is a communication terminal of the battery 300, and the contact 370c is a temperature output terminal of the battery 300. When the battery 300 is attached to the battery storage portion 160, the contacts 370b and 370c of the battery 300 are electrically connected to the contacts 170b and 170c of the camera body 100, and various kinds of information concerning the battery 300 and the digital camera are exchanged between the battery 300 and the camera body 100.

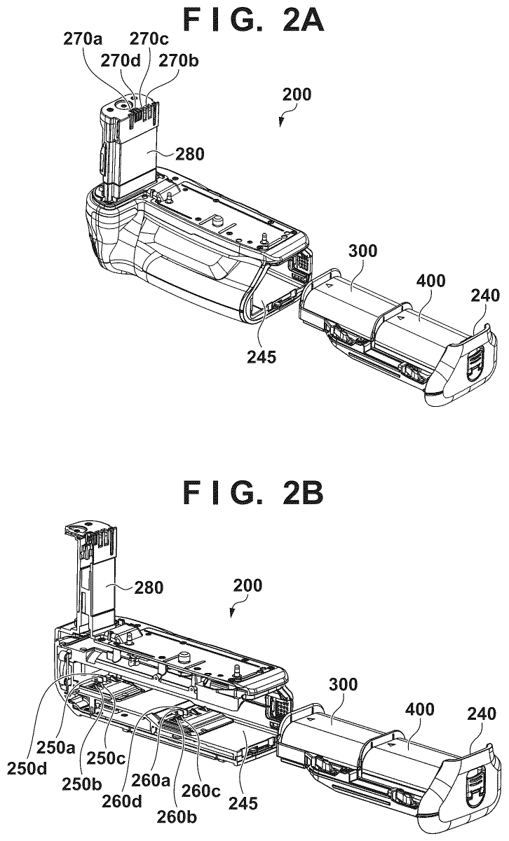

Next, with reference to FIGS. 2A and 2B, the outer appearances of a battery grip attachable to an electronic apparatus and batteries attachable to the battery grip, and a connection form according to the present embodiment will be described.

FIG. 2A is a perspective view illustrating the outer appearance of a battery grip attachable to a digital camera, the outer appearances of batteries attachable to the battery grip, and a connection form according to the present embodiment.

FIG. 2B is a perspective view illustrating the connection form between the battery grip and the batteries according the present embodiment in a state in which the battery grip attachable to a digital camera is partially cut out.

A battery grip 200 is an external apparatus attachable to the camera body 100. The battery grip 200 is an accessary apparatus that expands the function of a digital camera. A plurality of batteries, which are two batteries 300 and 400 in the present embodiment, can be attached to the battery grip 200. The battery grip 200 includes a magazine 240 that stores the plurality of batteries 300 and 400, and a magazine storage portion 245 that stores the magazine 240. The magazine 240 is provided with a slot for storing the first battery 300 and a slot for storing the second battery 400. The magazine storage portion 245 is provided with contacts 250a to 250d and contacts 260a to 260d that contact the contacts of the first battery 300 and the second battery 400 in a state in which the magazine 240 is attached.

The first battery 300 and the second battery 400 are batteries of the same type or different types. The battery type is, for example, the rated current, but not limited to this and may be the rated power.

In addition, the battery grip 200 is provided with a magazine connection portion 280 having a shape similar to the outer shape of each of the batteries 300 and 400, and attachable to the battery storage portion 160 of the camera body 100. The magazine connection portion 280 has a shape protruding from the magazine storage portion 245. The magazine connection portion 280 is provided with contacts 270a to 270d that contact the contacts 170a to 170d of the battery storage portion 160 in a state in which the magazine connection portion 280 is attached to the battery storage portion 160 of the camera body 100.

In a state in which the battery 300 is stored in the magazine 240, the contact 250a is electrically connected to the contact 370a which is the plus terminal of the battery 300, and the contact 250d is electrically connected to the contact 370d which is the minus terminal of the battery 300. In addition, in the state in which the battery 300 is stored in the magazine 240, the contact 250b is electrically connected to the contact 370b which is the communication terminal of the battery 300, and the contact 250c is electrically connected to the contact 370c which is the temperature output terminal of the battery 300.

The connection relationship between the contacts of the battery 400 and the contacts 260a to 260d of the magazine storage portion 245 is similar to the connection relationship between the contacts of the battery 300 and the contacts 250a to 250d of the magazine storage portion 245.

In a state in which the battery grip 200 is stored in the battery storage portion 160 of the camera body 100, the contact 270a is electrically connected to the contact 170a which is the plus terminal of the battery storage portion 160, and the contact 270d is electrically connected to the contact 170d which is the minus terminal of the battery storage portion 160. In addition, in the state in which the battery grip 200 is stored in the battery storage portion 160 of the camera body 100, the contact 270b is electrically connected to the contact 170b which is the communication terminal of the battery storage portion 160, and the contact 270c is electrically connected to the contact 170c which is the temperature output terminal of the battery storage portion 160.

In a state in which the magazine 240 storing the batteries 300 and 400 is stored in the magazine storage portion 245, when the battery grip 200 is attached to the camera body 100 and the magazine connection portion 280 is stored in the battery storage portion 160, the contacts of the first battery 300 and the second battery 400 are electrically connected to the contacts of the battery storage portion 160.

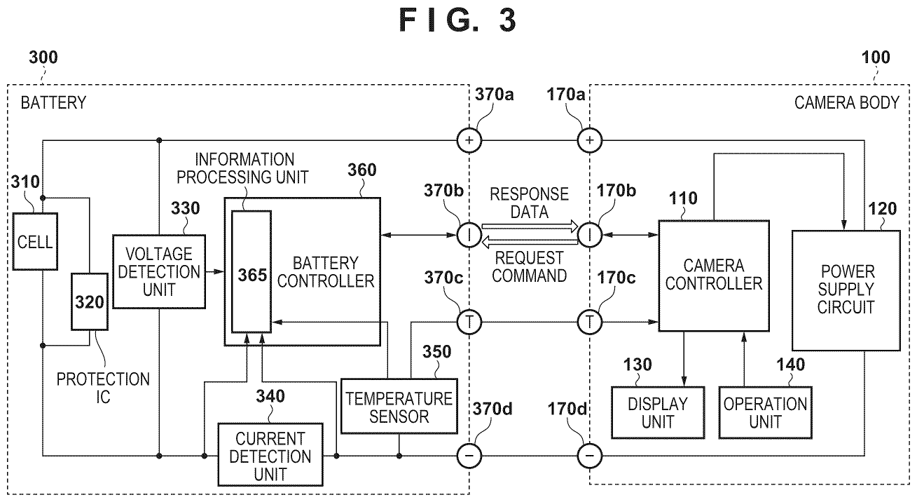

Next, with reference to FIG. 3, the internal configurations of the camera body 100 and the battery 300 according to the present embodiment, that are electrically connected in a state in which the battery 300 is stored in the camera body 100, will be described.

FIG. 3 is a block diagram illustrating the internal configurations of the digital camera and the battery attachable to the digital camera according to the present embodiment.

The battery 300 includes a cell 310, a protection IC 320, a voltage detection unit 330, a current detection unit 340, a temperature sensor 350, and a battery controller 360.

The cell 310 generates an electromotive force. The protection IC 320 has a function of protecting the cell 310 during charging/discharging. The voltage detection unit 330 detects the battery voltage which is the output voltage of the cell 310. The current detection unit 340 uses a resistor, and detects the battery current which is the output current of the cell 310. The temperature sensor 350 uses a thermistor or a thermocouple, and detects the internal temperature of the battery 300. The detection information of each of the voltage detection unit 330, the current detection unit 340, and the temperature sensor 350 is output to the battery controller 360. The battery controller 360 includes an information processing unit 365. The information processing unit 365 performs A/D conversion of the detection information of each of the voltage detection unit 330, the current detection unit 340, and the temperature sensor 350, and performs current integration.

The battery controller (to be referred to as the battery microcomputer hereinafter) 360 includes a processor (CPU) that performs control processing of the battery 300, a nonvolatile memory (ROM) that stores a program to be executed by the processor, and a work memory (RAM) to which the program read out from the nonvolatile memory, constants and variables for executing the program, and the like are loaded. The battery microcomputer 360 controls the respective components of the battery 300 by loading the program stored in the ROM to the RAM and executing it.

The camera body 100 includes a camera controller 110, a power supply circuit 120, a display unit 130, and an operation unit 140.

The battery 300 and the camera body 100 are connected at the contacts 370a and 370d and the contacts 170a and 170d, and power is supplied from the battery 300 to the camera body 100.

The camera controller (to be referred to as the camera microcomputer hereinafter) 110 includes a processor (CPU) that performs control processing of the camera body 100, a nonvolatile memory (ROM) that stores a program to be executed by the processor, and a work memory (RAM) to which the program read out from the nonvolatile memory, constants and variables for executing the program, and the like are loaded. The camera microcomputer 110 controls the respective components of the camera body 100 by loading the program stored in the ROM to the RAM and executing it.

The power supply circuit 120 uses a DC/DC converter or a linear regulator, and generates, based on the power supplied from the battery 300, a voltage on which the respective components of the camera body 100 can operate.

The display unit 130 uses a liquid crystal panel or the like, and displays an image shot by the digital camera, a GUI for setting the digital camera, setting information, and the like.

The operation unit 140 uses a switch, a button, a dial, a touch panel, or the like for accepting a user operation, and inform the camera microcomputer 110 of the information input by the user operation. When the camera microcomputer 110 transmits a request command to the battery microcomputer 360 via the contact 170b and the contact 370b, various kinds of information (to be referred to as battery information hereinafter) concerning the battery such as the remaining capacity, voltage, discharge current, temperature, type, and serial number of the battery 300 are returned from the battery 300. Based on the battery information, the camera microcomputer 110 calculates the operable time of the digital camera (to be referred to as the whole camera hereinafter) including the lens unit, and displays the operable time on the display unit 130 such as the liquid crystal panel. When the battery 300 is in a low temperature state, the internal resistance increases so that a voltage drop during discharge increases. Accordingly, the output capacity decreases. Therefore, the operable time is corrected based on the temperature information of the battery 300 obtained by communication or via the contact 370c and the contact 170c. Furthermore, the temperature information of the battery 300 is used to maintain the use temperature range of the battery 300.

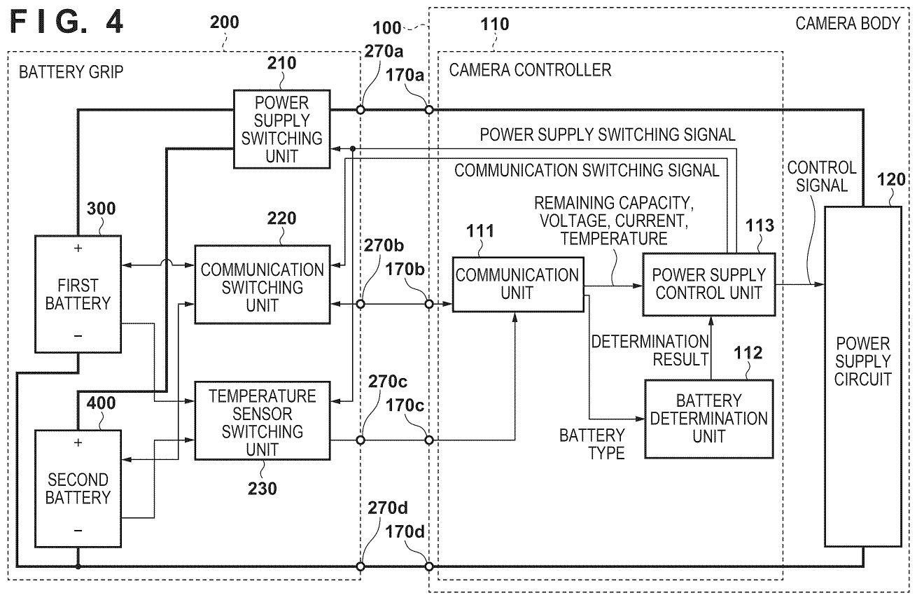

Next, with reference to FIG. 4, the internal configurations of a camera body 100 and a battery grip 200 according to the first embodiment, that are electrically connected in a state in which the battery grip 200 is stored in the camera body 100, will be described.

FIG. 4 is a block diagram illustrating the internal configurations of a digital camera and a battery grip attachable to the digital camera according to the first embodiment.

A first battery 300 and a second battery 400 are attached to the battery grip 200. The camera body 100 can be connected to only a single battery via contacts 170a to 170d and contacts 270a to 270d of the battery grip 200. Therefore, the battery grip 200 includes a switching unit for switching the battery connected to the contacts 270a to 270d.

The switching unit includes a power supply switching unit 210, a communication switching unit 220, and a temperature sensor switching unit 230.

The power supply switching unit 210 switches the connection of the contact for power supply (the plus terminal of the battery). The communication switching unit 220 switches the connection of the contact for communication (the communication terminal of the battery). The temperature sensor switching unit 230 switches the connection of the contact for temperature output (the temperature output terminal of the battery). Note that since the minus terminals of the first battery 300 and the second battery 400 are both connected to the reference potential of the electric circuit, a switching unit is unnecessary. When the communication method between the first and second batteries 300 and 400 and the camera body 100 is a format such as I2C in which a communication bus is shared by a plurality of devices, the communication switching unit 220 is unnecessary.

Switching control of these switching units may be executed by a power supply switching signal and a communication switching signal from the camera microcomputer 110, or may be executed by a microcomputer (not shown) of the battery grip 200. Note that the switching signals input to the power supply switching unit 210, the communication switching unit 220, and the temperature sensor switching unit 230 may be the same signal that is branched and input, or all different signals may be input. As in the example shown in FIG. 4, if the switching signal input to the power supply switching unit 210 and the temperature sensor switching unit 230 is different from the switching signal input to the communication switching unit 220, it is possible to communicate with either battery at an arbitrary timing. On the other hand, if the same signal is branched and input, it is possible to communicate with only the battery that is supplying power to the power supply circuit 120.

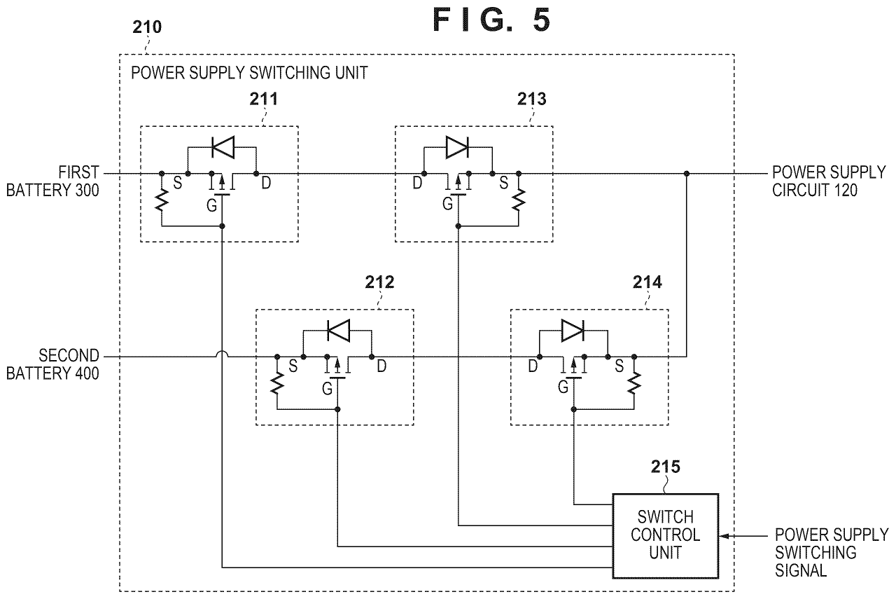

Here, with reference to FIG. 5, the operation of the power supply switching unit 210 according to the first embodiment will be described.

FIG. 5 is a circuit diagram illustrating the configurations of the power supply switching unit 210 according to the first embodiment.

The power supply switching unit 210 includes a plurality of switches 211 to 214, and a switch control unit 215 that controls opening/closing of these switches. Each of the plurality of switches 211 to 214 is formed from a p-channel MOSFET and a resistor.

The source (S) of the MOSFET of the switch 211 is connected to the plus terminal of the first battery 300. The source (S) of the MOSFET of the switch 212 is connected to the plus terminal of the second battery 400. The drain (D) of the MOSFET of the switch 211 is connected to the drain (D) of the MOSFET of the switch 213. The drain (D) of the MOSFET of the switch 212 is connected to the drain (D) of the MOSFET of the switch 214. The sources(S) of the MOSFETs of the switches 213 and 214 are both connected to the power supply circuit 120. All of the gates (G) of the MOSFETs of the switches 211 to 214 are connected to the switch control unit 215 and voltage-driven.

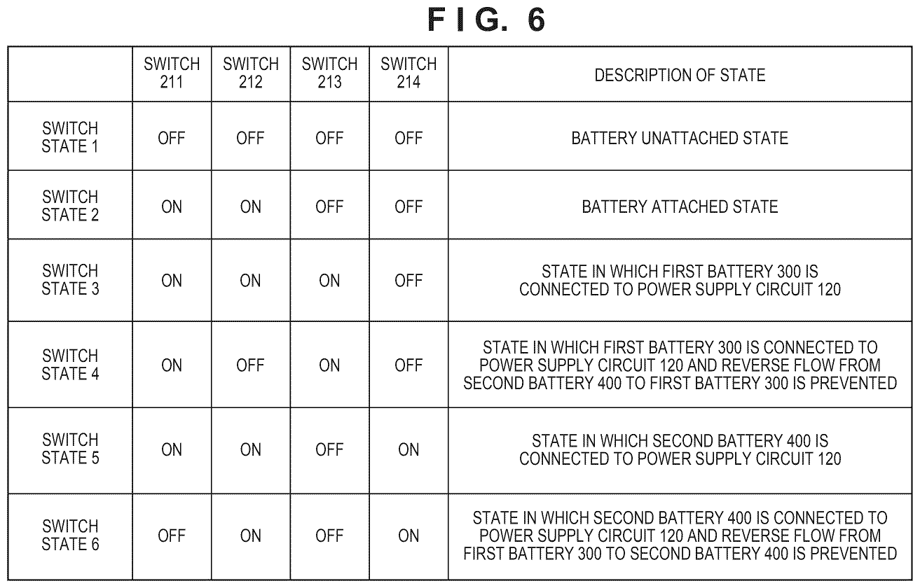

FIG. 6 is a view illustrating combinations of ON and OFF states of the switches 211 to 214 shown in FIG. 5.

In a state in which no battery is attached, the switches are set in a switch state 1. When batteries are attached, the switches are set in a switch state 2. When connecting the first battery 300 to the power supply circuit 120, the switches are set in a switch state 3. However, when the battery voltage of the second battery 400 is higher than the battery voltage of the first battery 300, and the difference in battery voltage is 0.7 V or more, which corresponds to the diode forward voltage, a current may flow reversely from the second battery 400 to the first battery 300 via the body diode of the MOSFET of the switch 214. To prevent this, the switches are set in a switch state 4. Similarly, when connecting the second battery 400 to the power supply circuit 120, the switches are set in a switch state 5. To prevent reverse flow of a current from the first battery 300 to the second battery 400, the switches are set in a switch state 6.

The switch state is switched by the power supply switching signal input to the switch control unit 215. For example, the switch state 3 or the switch state 4 may be continued to use up the power of the first battery 300 before switching to the switch state 5. Alternatively, the switch state 3 and the switch state 5 may be switched in a short time to alternately use the power of the first battery 300 and the power of the second battery 400 little by little. This can be selected in accordance with the operation mode of the camera body 100.

Referring back to the description of FIG. 5, when the batteries are attached, the switch control unit 215 switches the switches 211 to 214 to the switch state 1. Thereafter, the switch control unit 215 switches each of the switches 211 to 214 to the ON state or the OFF state in accordance with the power supply switching signal. In the first embodiment, there are a maximum of six switch states. Therefore, the power supply switching signal is configured as a binary 3-bit parallel signal line, a ternary 2-bit parallel signal line, or a serial communication line.

Referring back to the description of FIG. 4, the camera microcomputer 110 includes a communication unit 111, a battery determination unit 112, and a power supply control unit 113.

The communication unit 111 is connected to the communication switching unit 220 of the battery grip 200 via the contact 170b and the contact 270b of the battery grip 200, and connected to the temperature sensor switching unit 230 of the battery grip 200 via the contact 170c and the contact 270c of the battery grip 200.

The camera body 100 obtains, via the communication unit 111 of the camera microcomputer 110, information such as the remaining capacity, voltage, discharge current, temperature, and type of the battery attached to the battery grip 200. The battery type is sent from the communication unit 111 to the battery determination unit 112. Based on the battery type, the battery determination unit 112 determines whether each of the first battery 300 and the second battery 400 attached to the battery grip 200 is compatible with high power, and outputs the determination result to the power supply control unit 113. Note that a high power compatible battery is a high output battery which has a higher rated output than a high power incompatible battery, in which the supply power of the battery is always higher than the power consumption of the whole camera, and in which the rated current of the battery is not exceeded even if the battery voltage decreases. On the other hand, a high power incompatible battery is a battery which has a lower rated output than a high power compatible battery, and whose rated current can be exceeded along with a decrease of the battery voltage.

The battery type may be an ID assigned to each battery type, or may be the supply power information of the battery. When the battery type information is the ID, the ID is used to refer to the battery supply power information stored in advance in the battery determination unit 112, and the supply power of the battery is compared with the power consumption of the whole camera stored in advance. Thus, it is possible to determine whether the battery is compatible with high power. Alternatively, information indicating whether each type of battery is compatible with high power may be stored in the battery determination unit 112, and the ID may be used to refer to this information. Thus, it may be determined whether the battery is compatible with high power. On the other hand, when the battery type is the supply power information, the battery determination unit 112 may compare the supply power of the battery with the power consumption of the whole camera stored in advance, thereby determining whether the battery is compatible with high power.

The information such as the remaining capacity, voltage, discharge current, and temperature of the battery is sent from the communication unit 111 to the power supply control unit 113. Based on the remaining capacity, voltage, discharge current, temperature, and type of the battery, the power supply control unit 113 calculates the operable time of the whole camera based on the remaining capacity of the battery. The power supply control unit 113 executes shutdown processing of turning off the power supply when the operable time of the whole camera reaches zero, and controls the power supply circuit 120 to stop. Alternatively, the power supply control unit 113 may execute shutdown processing when both batteries reach the predetermined remaining capacity or voltage, and control the power supply circuit 120 to stop. The power supply control unit 113 controls the power supply switching unit 210 by the power supply switching signal based on the battery type or the operable time of the whole camera.

For example, in a case where the first battery 300 and the second battery 400 are attached, an operable time T [min] can be calculated by the following equation 1 using a remaining capacity C1 [mAh], a correction capacity CO1 [mAh], a discharge current I1[mA], and a correction coefficient k1 of the first battery 300, and a remaining capacity C2 [mAh], a correction capacity CO2 [mAh], a discharge current I2 [mA], and a correction coefficient k2 of the second battery 400.

T=[{(C1−CO1)×k1+(C2−CO2)×k2}/{(I1+I2)}]×60 (1)

In the above-described equation 1, the correction coefficients k1 and k2 are values for adjusting the operable time T to become zero in accordance with the battery voltage at which the digital camera is shut down. Furthermore, the correction capacities CO1 and CO2 are values for adjusting the battery voltage at which the digital camera is shut down. These values are set in accordance with the types of the first battery 300 and second battery 400 and the power consumption of the whole camera. When the remaining capacity of one battery reaches the correction capacity, the power supply control unit 113 switches the connection to the other battery. Note that if the camera is designed to be shut down in accordance with the remaining capacity or voltage of the battery instead of the operable time T, the connection to the battery is switched when the remaining capacity or voltage of the battery becomes lower than a threshold.

Here, a method of calculating the operable time T will be described for each combination of the battery types.

As the first example, assume a case where the first battery 300 and the second battery 400 are batteries of the same type, and both are high power incompatible batteries. For a high power incompatible battery, a situation can occur in which the supply power of the battery becomes lower than the power consumption of the whole camera. Therefore, there is a need to adjust the correction capacities CO1 and CO2 so as to shut down the digital camera before the supply power of the battery becomes lower than the power consumption of the whole camera. Assume that the remaining capacities C1 and C2 are 2,000 [mAh], the correction coefficients k1 and k2 are 1, I1 is 2,000 [mA], and I2is 0 [mA]. Furthermore, assume that the correction capacities CO1 and CO2 are 1,000 [mAh]. In this case, the operable time T is 60 [min].

Note that I2 is 0 [mA] because the power supply switching unit 210 connects the first battery 300 to the power supply circuit 120. The calculated operable time T is a value at the time when the remaining capacities C1 and C2 are 2,000 [mAh]. As the remaining capacities C1 and C2 decrease by driving the digital camera, the operable time T accordingly decreases.

As the second example, assume a case where the first battery 300 and the second battery 400 are batteries of the same type, and both are high power compatible batteries. Assume that the remaining capacities C1 and C2 are 2,000 [mAh], the correction coefficients k1 and k2 are 1, I1 is 1,000 [mA], and I2 is 0 [mA]. Furthermore, since a high power compatible battery can be used until the remaining capacity of the battery reaches 0 [mAh], the correction capacities CO1 and CO2 are set to 0 [mAh]. The operable time T in this case is 120 [min]. In this manner, by adjusting the correction capacity in accordance with the battery type, it is possible to increase the operable time T by 60 [min] as compared to a case of setting the correction capacity to 1,000 [mAh] as in the first example without adjusting the correction capacity in accordance with the battery type.

As the third example, assume a case where the first battery 300 and the second battery 400 are batteries of different types, and the first battery 300 and the second battery 400 are a high power compatible battery and a high power incompatible battery, respectively. Assume that the remaining capacities C1 and C2 are 2,000 [mAh], the correction coefficients k1 and k2 are 1, I1 is 2,000 [mA], and I2 is 0 [mA]. Furthermore, assume that the correction capacity CO1 is 0 [mAh], and the correction capacity CO2 is 1,000 [mAh]. In this case, the operable time T is 90 [min]. In this case as well, by adjusting the correction capacity in accordance with the battery type, it is possible to increase the operable time T by 30 [min] as compared to a case of setting the correction capacity to 1,000 [mAh] as in the first example without adjusting the correction capacity in accordance with the battery type.

In the first embodiment, the example has been described in which, when using a high power incompatible battery, the correction capacity is set to 1,000 [mAh] instead of 0 [mAh] because there is a need to stop using the battery before the supply power of the battery becomes lower than the power consumption of the whole camera. The correction capacity needs to be set to a safe value that prevents an instantaneous power interruption in the electronic apparatus, in consideration of the tolerance, temperature characteristic, aging deterioration, and the like of each electronic component constituting the electronic apparatus. In a case where one battery is compatible with high power as in the third example, by using the high power incompatible battery first, it is possible to switch to the high power compatible battery at the time when the remaining capacity of the high power incompatible battery reaches the correction capacity. Thus, no instantaneous power interruption occurs in the digital camera. In this case, the operable time T can be increased by decreasing the correction capacity of the high power incompatible battery. Note that when performing shutdown processing in accordance with the remaining capacity or voltage of the battery, it is possible to decrease the shutdown threshold for the remaining capacity or voltage of the high power incompatible battery, so that the operable time T can be increased.

A method of adjusting the correction capacity of a high power incompatible battery and a control method of the power supply switching unit 210 in a case of using a high power compatible battery and the high power incompatible battery in combination will be described below.

For example, assume a case where the first battery 300 is a high power compatible battery, and the second battery 400 is a high power incompatible battery. Assume that the remaining capacities C1 and C2 are 2,000 [mAh], the correction coefficients k1 and k2 are 1, I1 is 2,000 [mA], and I2 is 0 [mA]. Furthermore, assume that the correction capacity CO1 is 0 [mAh], and the correction capacity CO2 is decreased from 1,000 [mAh] to 500 [mAh]. The operable time T in this case is 105 [min]. As compared to the case where the correction capacity CO2 is 1,000 [mAh], the operable time T is increased by 15 [min].

The correction capacity CO2 may be decided while ignoring, for example, the tolerance, temperature characteristic, aging deterioration, and the like of each electronic component constituting the electronic apparatus. Note that since a battery is provided with an overcurrent protection function which prevents damage to the battery if a current exceeding the rated current flows, it is also possible to configure such that the correction capacity CO2 is set to 0 [mAh] and the battery is used until the overcurrent protection function is activated to stop the output of the battery. In this case, since the time before the output of the battery stops is unknown, it is impossible to calculate the precise operable time T and display it on the display unit 130.

In order to switch from the high power incompatible battery to the high power compatible battery without causing an instantaneous power interruption in the digital camera, the respective switches need to be set in the switch state 5. That is, since a state needs to be set in which a current can be supplied via the body diode of the MOSFET forming the switch 213, the switch state 6 needs to be avoided. Accordingly, there is a need to prevent a current flowing from the first battery 300 to the second battery 400 even in the switch state 5, so that the voltage difference between the first battery 300 and the second battery 400 needs to be always lower than 0.7 V. In order to implement this, the first battery 300 and the second battery 400 may be controlled to be used alternately, or a switch having the same configuration as the switch 213 may be further provided in series with the switch 213 to prevent a current flowing at the voltage difference of 0.7 V.

Similarly, in a case where the first battery 300 is a high power incompatible battery and the second battery 400 is a high power compatible battery, the respective switches need to be set in the switch state 3, and avoid the switch state 4.

In the present embodiment, it has been descried that a high power compatible battery is a battery in which the supply power of the battery is always higher than the power consumption of the whole camera, but it is not limited to this example. For example, when the supply powers of the attached batteries of different types are both lower than the power consumption of the whole camera, the first embodiment may be applied while regarding the battery having a relatively high supply power as a high power compatible battery. In this case, the correction capacity of the high power compatible battery is set to, for example, 500 [mAh] instead of 0 [mAh].

According to the first embodiment, it is possible to make maximum use of a plurality of types of batteries attached to the camera body 100. More specifically, by adjusting the information such as the correction capacity of the battery in accordance with the battery type, the operable time T can be increased as compared to a case of not adjusting the information. Furthermore, when using a high power compatible battery and a high power incompatible battery in combination, by decreasing the correction capacity of the high power incompatible battery, the operable time T can be increased more.

### Second Embodiment

Next, a second embodiment will be described.

In the second embodiment, an example of increasing an operable time T when information such as the correction capacity cannot be adjusted for each battery will be described.

The second embodiment is different from the first embodiment in that a power supply control unit 113a of a camera microcomputer 110a does not output a power supply switching signal and a communication switching signal but a power supply switching unit 210a of a battery grip 200a outputs a communication switching signal and a temperature sensor switching signal. Other components that are similar to those in the first embodiment are denoted by the same reference numerals as those in the first embodiment.

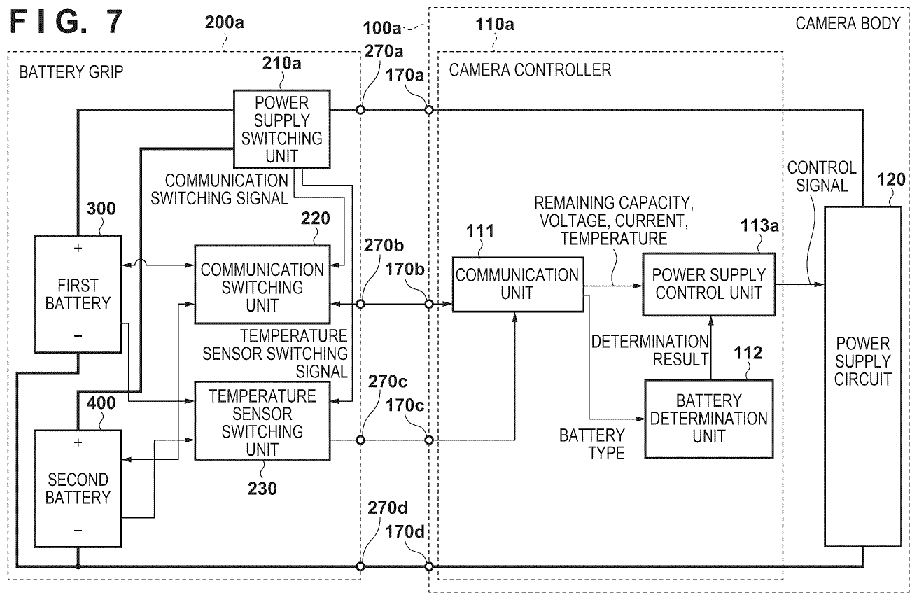

FIG. 7 is a block diagram illustrating the internal configurations of a digital camera and a battery attachable to the digital camera according to the second embodiment.

In addition to switching control of the connection of the battery to supply power, the power supply switching unit 210a of the battery grip 200a outputs a communication switching signal and a temperature sensor switching signal for performing switching control of a communication switching unit 220 and a temperature sensor switching unit 230. Note that switching control of the communication switching unit 220 and the temperature sensor switching unit 230 may be executed by a microcomputer (not shown) of the battery grip 200a.

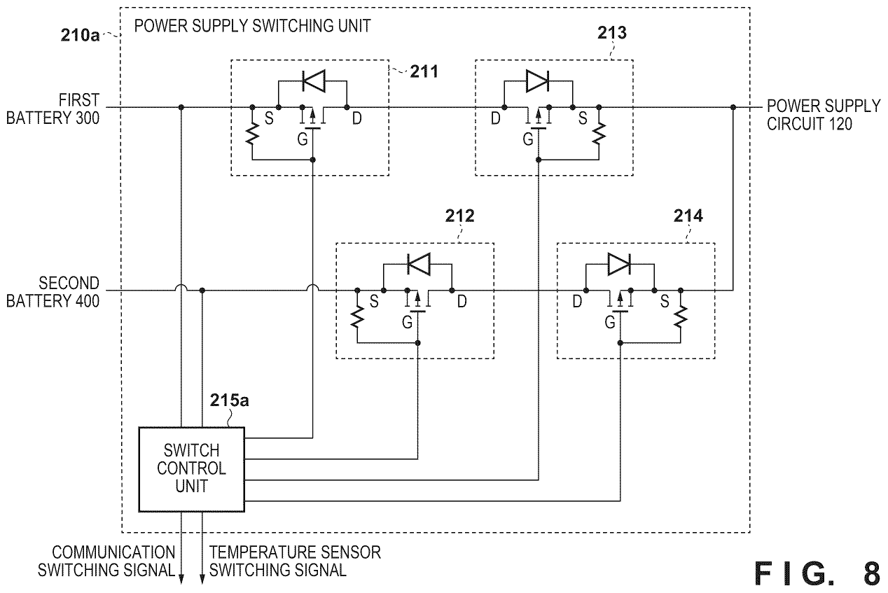

With reference to FIG. 8, the operation of the power supply switching unit 210a according to the second embodiment will be described.

FIG. 8 is a circuit diagram illustrating the configurations of the power supply switching unit 210a according to the second embodiment.

The power supply switching unit 210a includes a plurality of switches 211 to 214, and a switch control unit 215a that controls opening/closing of these switches. The configurations of the plurality of switches 211 to 214 are similar to those in FIG. 5 according to the first embodiment.

The switch control unit 215a compares the voltage of a first battery 300 and the voltage of a second battery 400, and controls the switch 213 and the switch 214 so as to connect the battery having a higher voltage to a power supply circuit 120. That is, it is configured such that the battery having a higher voltage is always connected to the power supply circuit 120. Therefore, switching control by the power supply control unit 113a is unnecessary, and the configurations of the system can be simplified. However, since the power supply switching unit 210a selects the battery to be connected to the power supply circuit 120 based on the battery voltage comparison result, it cannot disconnect the battery having a higher voltage from the power supply circuit 120 and connect the battery having a lower voltage to the power supply circuit 120. Hence, in a case of using batteries of different types in combination, there is a need to execute shutdown processing to stop the power supply circuit at the time when the remaining capacity of the high power incompatible battery reaches the correction capacity even though the remaining capacity of the high power compatible battery has not reached the correction capacity.

As the first example, assume a case where the first battery 300 and the second battery 400 are batteries of the same type, and both are high power incompatible batteries. Assume that remaining capacities C1 and C2 are 2,000 [mAh], correction coefficients k1 and k2 are 1, I1 is 2,000 [mA], and I2 is 0 [mA]. Furthermore, assume that correction capacities CO1 and CO2 are 1,000 [mAh]. In this case, the operable time T is 60 [min] as in the first embodiment.

As the second example, assume a case where the first battery 300 and the second battery 400 are batteries of the same type, and both are high power compatible batteries. In the second embodiment as well, when high power compatible batteries are attached as batteries of the same type, by adjusting the correction capacity or the like as in the first embodiment, it is possible to increase the operable time T as compared to a case of not adjusting the correction capacity in accordance with the battery type. For example, assume that the remaining capacities C1 and C2 are 2,000 [mAh], the correction coefficients k1 and k2 are 1, I1 is 1,000 [mA], and I2 is 0 [mA]. Furthermore, since the first battery 300 and the second battery 400 are high power compatible batteries whose rated currents are not exceeded, they can be used until the remaining capacity reaches 0 [mAh]. Hence, the correction capacities CO1 and CO2 are set to 0 [mAh]. The operable time T in this case is 120 [min].

As the third example, assume a case where the first battery 300 and the second battery 400 are batteries of different types, and the first battery 300 and the second battery 400 are a high power compatible battery and a high power incompatible battery, respectively. Assume that the remaining capacities C1 and C2 are 2,000 [mAh], the correction coefficients k1 and k2 are 1, I1 is 2,000 [mA], and 12 is 0 [mA]. Since the first battery 300 is a high power compatible battery and can be used until the remaining capacity reaches 0 [mAh], the correction capacity CO1 can be set to 0 [mAh]. However, in the second embodiment, there is a need to execute shutdown processing at the time when the remaining capacity of the high power incompatible battery reaches the correction capacity even though the remaining capacity of the high power compatible battery has not reached the correction capacity. Therefore, there is a need to set the correction capacity CO1 to 1,000 [mAh], which is the same value as the correction capacity CO2. Accordingly, the operable time T in this case is 60 [min]. Even if one battery is a high power compatible battery, the operable time T cannot be increased.

However, as in the first embodiment, when using a high power compatible battery and a high power incompatible battery in combination, the correction capacity of the high power incompatible battery may be adjusted so as to increase the operable time T, and accordingly the correction capacity of the high power compatible battery may also be adjusted so as to increase the operable time T.

As the fourth example, assume a case where the first battery 300 is a high power compatible battery, and the second battery 400 is a high power incompatible battery. Assume that the remaining capacities C1 and C2 are 2,000 [mAh], the correction coefficients k1 and k2 are 1, I1 is 2,000 [mA], and I2 is 0 [mA]. Furthermore, assume that the correction capacity CO2 is decreased from 1,000 [mAh] to 500 [mAh]. On the other hand, the correction capacity CO1 can be set to 0 [mAh]. However, in the second embodiment, for the above-described reason, the correction capacity CO1 needs to be set to 500 [mAh], which is the same value as the correction capacity CO2. The operable time T in this case is 90 [min]. The operable time T is increased by 30 [min] as compared to a case where the correction capacities CO1 and CO2 are 1,000 [mAh].

In order to avoid high-speed switching of the switches 213 and 214 by the switch control unit 215a , a suitable hysteresis voltage may be provided in voltage comparison. By using a minimum switching cycle Ts [min] of the switch and a voltage drop AV [V/min] per unit time, which is decided from the power consumption of the whole camera and the battery discharge curve, a hysteresis voltage Vh [V] can be calculated by:

Vh=Ts×ΔV (2)

From the above-described equation 2, for example, when the minimum switching cycle is 1 [min] and the voltage drop ΔV per unit time is 0.04 [V/min], the hysteresis voltage Vh [V] may be set to 0.4 V or more.

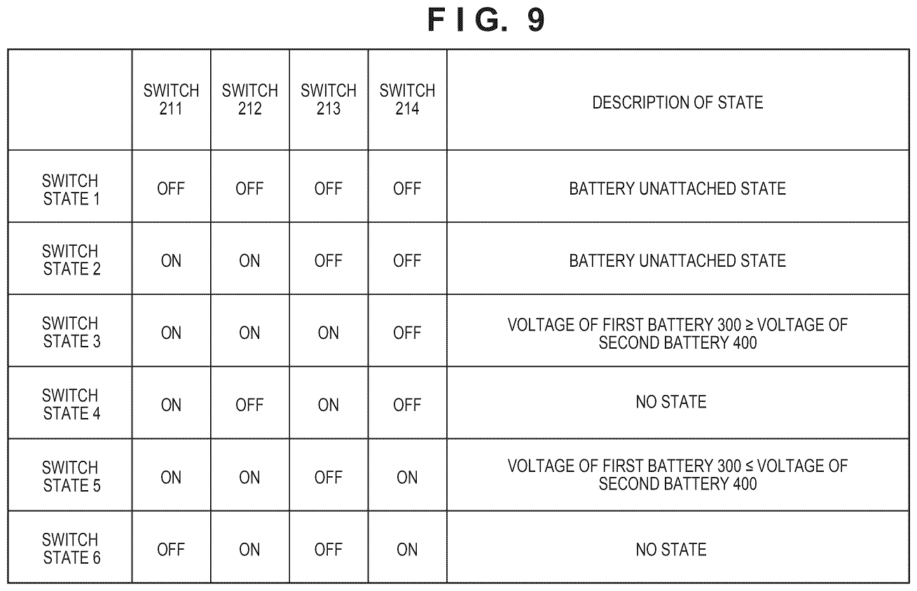

FIG. 9 is a view illustrating combinations of ON and OFF states of the switches 211 to 214 shown in FIG. 8.

In a state in which no battery is attached, the switches are set in a switch state 1. When batteries are attached, the switches are set in a switch state 2. When the voltage of the first battery 300 is higher than the voltage of the second battery 400, the switches are set in a switch state 3. When the voltage of the second battery 400 is higher than the voltage of the first battery 300, the switches are set in a switch state 5. Note that in the second embodiment, since a diode is always placed in the opposite direction between a battery having a high voltage and a battery having a low voltage, the inflow of a current to the battery does not occur. Hence, a switch state 4 and a switch state 6 are not set.

In the second embodiment, as in the first embodiment, it has been described that a battery in which the supply power of the battery is always higher than the power consumption of the whole camera is a high power compatible battery, but the present disclosure is not limited to this example. For example, when the supply powers of all of the batteries of different types attached to a camera body 100a are lower than the power consumption of the whole camera, the second embodiment may be applied while regarding the battery having a relatively high supply power as a high power compatible battery.

According to the second embodiment, it is possible to make maximum use of a plurality of types of batteries attached to the camera body 100a. More specifically, even when information such as the correction capacity cannot be adjusted for each battery attached to the camera body 100a, when batteries of the same type are attached, the information is adjusted in accordance with the type. With this, the operable time T can be increased as compared to a case of not adjusting the information. Furthermore, when using a high power compatible battery and a high power incompatible battery in combination, by adjusting the correction capacity of the high power incompatible battery to be smaller and accordingly adjusting the correction capacity of the high power compatible battery to be smaller, the operable time T can be increased more.

According to the present disclosure, it is possible to make maximum use of the plurality of types of batteries attached to an electronic apparatus, thereby increasing the operable time of the electronic apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-102223, filed Jun. 25, 2024 which is hereby incorporated by reference herein in its entirety.

What is claimed is:

1. An electronic apparatus that can be attached with a plurality of batteries, comprising:
a control unit configured to switch a battery for supplying power to the apparatus based on information indicating a power supply state of each of the plurality of batteries and, when the information meets a predetermined case for the plurality of batteries, perform shutdown processing of the apparatus,
wherein the control unit obtains the information in a manner that differs between a case where the plurality of batteries are of the same type and a case where the plurality of batteries are of different types.

2. The apparatus according to claim 1, further comprising:
a connection unit to which the plurality of batteries can be attached;
a determination unit configured to determine types of the plurality of batteries; and
a calculation unit configured to calculate the information.

3. The apparatus according to claim 2, wherein
the calculation unit
calculates the information using the same calculation method for the plurality of batteries when the plurality of batteries are of the same type, and
when the plurality of batteries are of different types, changes a calculation method of the information for a battery having a low rated output among the plurality of batteries so as to increase an operable time of the apparatus.

4. The apparatus according to claim 3, wherein
the control unit controls such that power of the battery having the low rated output among the plurality of batteries is consumed first.

5. The apparatus according to claim 2, wherein
the calculation unit
calculates the information using the same calculation method for the plurality of batteries when the plurality of batteries are of the same type, and
when the plurality of batteries are of different types, changes a calculation method of the information for another battery in accordance with a battery having a low rated output among the plurality of batteries.

6. The apparatus according to claim 2, wherein
the connection unit can be attached with an external apparatus to which the plurality of batteries are attached, and
the external apparatus includes a switching unit configured to switch a battery for supplying power to the apparatus.

7. The apparatus according to claim 6, wherein
the switching unit includes a plurality of switches used to switch a battery for supplying power to the apparatus, and
the control unit controls each of the plurality of switches to one of an ON state and an OFF state.

8. The apparatus according to claim 7, wherein
the control unit controls each of the plurality of switches to one of an ON state and an OFF state such that no current flows from a battery that does not supply power to the apparatus to a battery that supplies power to the apparatus.

9. The apparatus according to claim 6, wherein
the switching unit includes a plurality of switches used to switch a battery for supplying power to the apparatus, and controls each of the plurality of switches to one of an ON state and an OFF state.

10. The apparatus according to claim 9, wherein
the switching unit controls ON states and OFF states of the plurality of switches such that a battery having a higher supply power among the plurality of batteries supplies power to the apparatus

11. The apparatus according to claim 1, wherein
a case where the plurality of batteries are of different types is a case where one of the plurality of batteries is a high power compatible battery in which a supply power of the battery is higher than power consumption of the apparatus, and another of the plurality of batteries is a high power incompatible battery in which a supply power of the battery is lower than power consumption of the apparatus.

12. The apparatus according to claim 1, wherein
a case where the plurality of batteries are of the same type is one of a case where all of the plurality of batteries are high power compatible batteries in which a supply power of the battery is higher than power consumption of the apparatus, and a case where all of the plurality of batteries are high power incompatible batteries in which a supply power of the battery is lower than power consumption of the apparatus.

13. The apparatus according to claim 1, wherein
the information is one of an operable time of the apparatus which is calculated based on remaining capacities and discharge currents of the plurality of batteries, voltages of the plurality of batteries, and remaining capacities of the plurality of batteries, and the predetermined case is one of a case where the operable time is zero and a case where one of the voltages and remaining capacities of the plurality of batteries is lower than a threshold.

14. The apparatus according to claim 13, wherein
an operable time of the apparatus is corrected to become zero in accordance with a battery voltage at which the shutdown processing is performed.

15. The apparatus according to claim 1, wherein
the apparatus is an image capturing apparatus.

16. A control method of an electronic apparatus that can be attached with a plurality of batteries, the method comprising:
switching a battery for supplying power to the electronic apparatus based on information indicating power supply states of the plurality of batteries; and
performing shutdown processing of the electronic apparatus when the information meets a predetermined case for the plurality of batteries,
wherein the switching is obtaining the information in a manner that differs between a case where the plurality of batteries are of the same type and a case where the plurality of batteries are of different types.

17. A non-transitory computer-readable storage medium storing a program for causing a computer to function as an electronic apparatus that can be attached with a plurality of batteries, comprising
a control unit configured to switch a battery for supplying power to the apparatus based on information indicating a power supply state of each of the plurality of batteries and, when the information meets a predetermined case for the plurality of batteries, perform shutdown processing of the apparatus,
wherein the control unit obtains the information in a manner that differs between a case where the plurality of batteries are of the same type and a case where the plurality of batteries are of different types.
